(19) United States
(12) Patent Application Publication
(10) Pub. No.: US 2026/0259886 A1
(43) Pub. Date: Sep. 3, 2026

(54) DATA PROCESSING METHOD AND APPARATUS, AND PROGRAM PRODUCT

(71) Applicant: Lenovo (Beijing) Limited, Beijing (CN)

(72) Inventors: Xiaona SUN, Beijing (CN); Ming HE, Beijing (CN)

(21) Appl. No.: 19/533,842

(22) Filed: Feb. 9, 2026

(30) Foreign Application Priority Data
Feb. 28, 2025 (CN) 202510233116.8

(51) Int. Cl. G06F 16/2457; G06N 5/045; G06N 20/00

(52) U.S. Cl. CPC G06F 16/24578; G06N 5/045; G06N 20/00

(57) ABSTRACT

A data processing method includes performing a plurality rounds of model reasoning, including, for a current round of model reasoning among the plurality rounds of model reasoning, determining, based on preceding specific reflection information corresponding to a preceding round of model reasoning, current prompt information of the current round of model reasoning, and executing, based on the current prompt information, the current round of model reasoning using a target model to obtain a current reasoning result of the current round of model reasoning. The preceding specific reflection information is generated based on preceding process information of the preceding round of model reasoning and high-level reflection information representing cross-task reflection information generated by the target model. The method further includes determining a target reasoning result based on one or more reasoning results from at least two rounds of model reasoning among the plurality of rounds of model reasoning.

### CROSS-REFERENCE TO RELATED APPLICATION

This application claims priority to Chinese Patent Application No. 202510233116.8, filed on Feb. 28, 2025, the entire content of which is incorporated herein by reference.

### TECHNICAL FIELD

The present disclosure generally relates to the field of computer technologies and, more particularly, to a data processing method and apparatus, and a program product.

### BACKGROUND

A large language model (LLM) is designed to be an autonomous language agent, enabling it to perform goal-oriented, multi-step tasks. However, in the autonomous language agent, content generated by the large language model still faces issues of accuracy and appropriateness.

### SUMMARY

In accordance with the disclosure, there is provided a data processing method including performing a plurality rounds of model reasoning, including, for a current round of model reasoning among the plurality rounds of model reasoning, determining, based on preceding specific reflection information corresponding to a preceding round of model reasoning, current prompt information of the current round of model reasoning, and executing, based on the current prompt information, the current round of model reasoning using a target model to obtain a current reasoning result of the current round of model reasoning. The preceding specific reflection information is generated based on preceding process information of the preceding round of model reasoning and high-level reflection information representing cross-task reflection information generated by the target model. The method further includes determining a target reasoning result based on one or more reasoning results from at least two rounds of model reasoning among the plurality of rounds of model reasoning.

Also in accordance with the disclosure, there is provided an electronic device comprising: one or more processors, and one or more memories storing instructions that, when executed by the one or more processors, cause the electronic device to perform a plurality rounds of model reasoning, including, for a current round of model reasoning among the plurality rounds of model reasoning, determining, based on preceding specific reflection information corresponding to a preceding round of model reasoning, current prompt information of the current round of model reasoning, and executing, based on the current prompt information, the current round of model reasoning using a target model to obtain a current reasoning result of the current round of model reasoning. The preceding specific reflection information is generated based on preceding process information of the preceding round of model reasoning and high-level reflection information representing cross-task reflection information generated by the target model. The instructions, when executed by the one or more processors, further cause the electronic device to determine a target reasoning result based on one or more reasoning results from at least two rounds of model reasoning among the plurality of rounds of model reasoning.

Also in accordance with the disclosure, there is provided a non-transitory computer-readable storage medium storing instructions that, when executed by one or more processors, cause an electronic device including the one or more processors to perform a plurality rounds of model reasoning, including, for a current round of model reasoning among the plurality rounds of model reasoning, determining, based on preceding specific reflection information corresponding to a preceding round of model reasoning, current prompt information of the current round of model reasoning, and executing, based on the current prompt information, the current round of model reasoning using a target model to obtain a current reasoning result of the current round of model reasoning. The preceding specific reflection information is generated based on preceding process information of the preceding round of model reasoning and high-level reflection information representing cross-task reflection information generated by the target model. The instructions, when executed by the one or more processors, further cause the electronic device to determine a target reasoning result based on one or more reasoning results from at least two rounds of model reasoning among the plurality of rounds of model reasoning.

### BRIEF DESCRIPTION OF THE DRAWINGS

FIG. 1 is a flow chart of a data processing method consistent with embodiments of the present disclosure.

FIG. 2 is a flow chart showing the implementation of a data processing method consistent with embodiments of the present disclosure.

FIG. 3 is a schematic diagram showing updating of high-level reflection information in a data processing method consistent with embodiments of the present disclosure.

FIG. 4 is a schematic structural diagram of a data processing apparatus consistent with embodiments of the present disclosure.

FIG. 5 is a hardware structural diagram of an electronic device consistent with embodiments of the present disclosure.

### DETAILED DESCRIPTION OF THE EMBODIMENTS

Various schemes and features of the present disclosure are described herein with reference to the accompanying drawings. The embodiments in the present disclosure are only used to describe the present disclosure and are not intended to limit the scope of the present disclosure. It is understandable that other embodiments obtained by those skilled in the art without inventive effort are within the scope of the present disclosure.

In the following description, references to “some embodiments” describe a subset of all possible embodiments. However, it is understood that “some embodiments” may be the same or different subsets of all possible embodiments and may be combined with each other without conflict.

The terms “first/second/third” are used merely to distinguish similar objects and do not represent a specific ordering of objects. It is understood that “first/second/third” may be interchanged in a specific order or sequence where permitted, such that the embodiments of the present disclosure described herein can be implemented in orders other than those illustrated or described herein.

Unless otherwise defined, all technical and scientific terms used in the present disclosure have the same meaning as those generally understood by those skilled in the art. The terms used in the present disclosure are only for the purpose of description and are not intended to limit the scope of the present disclosure.

To improve accuracy and appropriateness of content generated by an LLM, self-correction and self-reflection are used to compensate for the limitations of the LLM in existing technologies. For example, in the Reflexion framework, when the model performs an autonomous language agent task, it is not necessary to update the model's weight parameters, and instead the language agent is strengthened through language feedback. For example, the Reflexion framework uses natural language to reflect the feedback signals of the task (such as the correctness of the answer) and generates a specific reflection text buffer in the episodic memory for making better decisions in subsequent model reasoning.

However, using the model's self-correction and self-reflection capabilities to improve the accuracy and appropriateness of content generated by the model has the following problems.

First, it requires the use of real labels to guide the self-correction process. For example, after receiving an initial response, the LLM generates a specific reflection text and adds external feedback information for that initial response in the context such as “answer correct” or “answer incorrect.” However, in actual testing environments, this external feedback information is unusable (i.e., the standard answer to the question cannot be known in advance).

Second, true labels are needed to determine when to stop the self-correction loop; that is, they are needed to verify the answer at each step. If the answer is incorrect, self-correction is performed; while if the answer is correct, self-correction is not performed. It can be seen that the use of true labels here is counterintuitive, because correcting only incorrect answers implies that the answer is known.

Third, when the use of true labels is directly removed and the model is allowed to decide when to stop self-correction by itself, tests show that the accuracy of the model (e.g., the GPT-3.5 or GPT-4 models in the Generative Pre-trained Transformer (GPT) series) decreases on datasets such as HotPotQA or CommonSenseQA.

The present disclosure provides a data processing method. First, based on specific reflection information corresponding to a preceding round of model reasoning, prompt information of a current round of model reasoning may be determined. The specific reflection information corresponding to the preceding round of model reasoning may be generated based on process information of the preceding round of model reasoning or high-level reflection information. The high-level reflection information may represent cross-task reflection information generated by a target model. Subsequently, based on the prompt information of the current round of model reasoning, the target model may be used to perform the current round of model reasoning to obtain a reasoning result of the current round of model reasoning. Then, based on reasoning results of at least two rounds of model reasoning, a target reasoning result may be determined. By using the cross-task high-level reflection information to guide the generation of specific reflection information corresponding to the preceding round of model reasoning and determining the prompt information for the current round of model reasoning based on this specific reflection information, cross-task and summative experience information may be used to guide the current model reasoning, making it easier for the target model to determine the correct model reasoning steps. On the other hand, by using the cross-task high-level reflection information to guide the model to generate the specific reflection information, compared to existing technologies that use real labels to guide the model to self-correct, the present disclosure may have higher feasibility in practical application scenarios.

The method provided by the present disclosure may be executed by an electronic device, which may be a laptop, tablet, desktop computer, set-top box, mobile device (e.g., mobile phone, portable music player, personal digital assistant, dedicated messaging device, portable gaming device), or a server. The server may be a standalone physical server, a server cluster or distributed system composed of multiple physical servers, or a cloud server providing basic cloud computing services such as cloud services, cloud databases, cloud computing, cloud functions, cloud storage, network services, cloud communication, middleware services, domain name services, security services, content delivery networks (CDNs), or big data and artificial intelligence platforms.

The technical solutions of the present disclosure will now be clearly and completely described with reference to the accompanying drawings.

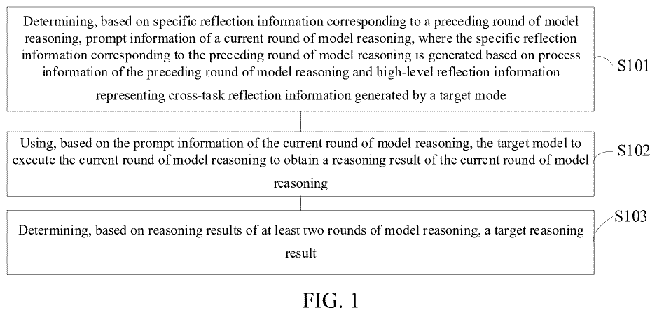

As shown in FIG. 1, which is a flowchart of a data processing method provided by the present disclosure, in one embodiment, the method includes S101 to S103.

At S101, based on specific reflection information corresponding to a preceding round of model reasoning, prompt information of a current round of model reasoning is determined. The specific reflection information corresponding to the preceding round of model reasoning may be generated based on process information of the preceding round of model reasoning and high-level reflection information, and the high-level reflection information may represent cross-task reflection information generated by a target model. The prompt information, specific reflection information, and process information of the current round of model reasoning are also referred to as “current prompt information,” “current specific reflection information,” and “current process information,” respectively, and similarly the prompt information, specific reflection information, and process information of the preceding round of model reasoning is also referred to as “preceding prompt information,” “preceding specific reflection information,” and “preceding process information,” respectively.

After the target model receives a target task, the target model may iteratively execute multiple rounds of model reasoning for the target task to determine a target reasoning result of the target task.

The target model may be of any type. For example, the target model may be an LLM, an LLM-based Vision Language Model (VLM), etc. In some embodiments, the target model may be an improved model supporting the Reflexion framework.

The target task may be any type of model processing task. For example, the target task may be a text-to-text task, a text-to-image task, an image recognition task, an image-to-text task, an image-to-image task, and so on. In some embodiments, the target task may be a task obtained through any suitable means. For example, the target task may be a task obtained through user input, or a task determined by automatically recognizing interaction data between a user and other applications running on the electronic device; and so on.

Each round of model reasoning may be a model processing procedure performed by the target model according to specified model reasoning rules for the target task. Each round of model reasoning may have a corresponding reasoning result. In some embodiments, the model reasoning rules may be model reasoning rules determined according to specified model reasoning examples, or model reasoning rules determined according to reasoning logic specified in natural language. The reasoning result corresponding to each round of model reasoning may represent that the reasoning is complete or that the reasoning is not complete. For example, when no result for the target task is obtained after completing the specified maximum number of reasoning steps, the reasoning may be considered incomplete. When a result for the target task is obtained after completing the specified maximum number of reasoning steps, the reasoning may be considered complete.

The target model may iteratively execute multiple rounds of model reasoning, meaning that the target model sequentially performs the multiple rounds of model reasoning. In adjacent rounds of model reasoning, the reasoning process of the current round may be adjusted based on at least the process information of the preceding round. In one embodiment, the current round of model reasoning may determine the prompt information based on the specific reflection information corresponding to the preceding round, where the specific reflection information corresponding to the preceding round of model reasoning may be generated based on the process information of the preceding round and high-level reflection information. The high-level reflection information may represent the cross-task reflection information generated by the target model.

The process information of model reasoning, i.e., the reasoning trajectory information, of each round of model reasoning, may be steps or paths followed by the model when performing model reasoning. In one embodiment, the process information of model reasoning may include, but is not limited to, information on the processing of input data, information on the feature extraction of the input data, information on the application of reasoning algorithms, or information on the algorithm for generating reasoning results.

The reflection information may be the information obtained after analyzing and evaluating the model's reasoning behavior and/or output during the reasoning process.

The reflection information may be of any form. In some embodiments, the reflection information may be information presented using natural language, such as text information presented using natural language. In some other embodiments, the reflection information may be information presented using feature representations, such as feature representations presented in any form that the model can understand, such as numerical vectors, matrices, or higher-dimensional tensors.

The reflection information may be information used to analyze and evaluate any stage of the model's reasoning process. In some embodiments, the reflection information may be any type of information related to the correctness of reasoning steps, the reasonableness of output results, the transparency of the decision-making process, performance, or other aspects of the model's reasoning process or intermediate results.

The high-level reflection information may be the cross-task reflection information corresponding to the model and may be used to guide the model in handling different specific tasks.

In some embodiments, the high-level reflection information may be information presented using natural language and/or feature representations.

In some embodiments, the high-level reflection information may be experience information manually summarized by staff based on the model's reasoning performance in handling one or more tasks.

In some embodiments, the high-level reflection information may be summative experience information generated by the model based on its own reasoning process in handling one or more tasks.

In some embodiments, the high-level reflection information may be reflection information updated according to a preset time period. For example, according to a preset time period, the reasoning task completed within that time period may be analyzed and evaluated by humans or a model, thereby updating the high-level reflection information.

In some embodiments, during the execution of a specific task, the model may analyze and evaluate each round of model reasoning, and update the original high-level reflection information based on the analysis and evaluation results, resulting in updated high-level reflection information.

The high-level reflection information may provide multiple reflection perspectives or experiences for different historical problems, better guiding the generation of specific reflection information.

The specific reflection information may be reflection information generated by the model during the execution of a specific task, for the complete reasoning process of that task and/or for one round of model reasoning. In some embodiments of the present disclosure, the specific reflection information may be reflection information generated by the target model for one round of model reasoning when executing the target task. For example, the specific reflection information may be “In this round of reasoning, I did not get the answer because . . . in the next round of reasoning, I will first search . . . ,” etc.

In some embodiments, the specific reflection information may be information presented using natural language and/or feature representation. In some embodiments, the specific reflection information may be hidden state information generated during the model reasoning process.

The specific reflection information corresponding to the preceding round of model reasoning may be generated based on the process information of the preceding round of model reasoning and high-level reflection information. That is, guided by the high-level reflection information, the target model may analyze and evaluate the process information of the preceding round of model reasoning to obtain the specific reflection information corresponding to the preceding round of model reasoning, which will be used to guide the current round of model reasoning.

In some embodiments, the specific reflection information corresponding to the preceding round of model reasoning may be used as part of the prompt information for the current round of model reasoning, thereby determining the prompt information for the current round of model reasoning based on the specific reflection information corresponding to the preceding round of model reasoning.

In some embodiments, the prompt information of the preceding round of model reasoning may be adjusted under the guidance of the specific reflection information corresponding to the preceding round of model reasoning to obtain the prompt information of the current round of model reasoning. For example, when the specific reflection information corresponding to the preceding round of model reasoning is “adjust model reasoning steps,” the reasoning steps in the reasoning example of the preceding round of prompt information may be appropriately adjusted to obtain the prompt information for the current round of model reasoning.

At S102, based on the prompt information of the current round of model reasoning, the target model is used to perform the current round of model reasoning to obtain a reasoning result of the current round of model reasoning. The reasoning result of the current round of model reasoning is also referred to as a “current reasoning result,” and similarly the reasoning result of the preceding round of modeling is also referred to as a “preceding reasoning result.”

After determining the prompt information of the current round of model reasoning, this prompt information may be input into the target model. Based on this prompt information, the target model may perform model reasoning and obtain the reasoning result of the current round of model reasoning.

In some embodiments, after executing a specified maximum number of reasoning steps, when the target model generates the reasoning result for the target task, the target model may output a reasoning completion indicator. In some embodiments, the reasoning completion indicator may be the reasoning result output by the target model in natural language. In some other embodiments, the reasoning completion indicator may be a keyword in the target model's reasoning trajectory used to indicate reasoning completion, such as “finished.”

In some embodiments, after executing a specified maximum number of reasoning steps, when the target model does not obtain a reasoning result for the target task, the target model may output an incomplete reasoning indicator. In some embodiments, the incomplete reasoning indicator may be an error message output by the target model in natural language. In some other embodiments, the incomplete reasoning indicator may be a keyword in the target model's reasoning trajectory used to indicate incomplete reasoning, such as “unfinished.”

In some embodiments, after obtaining the reasoning result of the current round of model reasoning, the result may be stored in a reasoning result list. The target reasoning result may then be determined based on at least one reasoning result in this list.

At S103, the target reasoning result is determined based on reasoning results of at least two rounds of model reasoning.

After performing at least two rounds of model reasoning, the target reasoning result for the target task may be determined based on the obtained reasoning results.

Since model reasoning may have incomplete states, the reasoning results corresponding to at least two rounds of model reasoning may include at least two reasoning results or only one reasoning result. Therefore, when the reasoning results of at least two rounds of model reasoning are only one, that single reasoning result may be determined as the target reasoning result. When the reasoning results of at least two rounds of model reasoning are at least two, the reasoning result corresponding to the last round of model reasoning may be determined as the target reasoning result, or the reasoning result that appears most frequently among the at least two reasoning results may be determined as the target reasoning result.

In the data processing method provided by the present disclosure, the prompting information for the current round of model reasoning may be determined first based on the specific reflection information corresponding to the preceding round of model reasoning. The specific reflection information may be generated based on the process information and high-level reflection information of the preceding round of model reasoning, where the high-level reflection information may represent the cross-task reflection information generated by the target model. Then, based on the prompting information for the current round of model reasoning, the target model may be used to perform the current round of model reasoning to obtain the reasoning result. Finally, based on the reasoning results of at least two rounds of model reasoning, the target reasoning result may be determined. By using the cross-task high-level reflection information to guide the generation of the specific reflection information corresponding to the preceding round of model reasoning and determining the prompting information for the current round of model reasoning based on the specific reflection information, the use of cross-task, summative experience information to guide the current model reasoning may be achieved, making it easier for the target model to determine the correct model reasoning steps. On the other hand, by using the cross-task high-level reflection information to guide the model in generating the specific reflection information, compared to existing technologies that use real labels to guide the model's self-correction, the present disclosure may have higher feasibility in practical application scenarios.

In some embodiments, the data processing method may further include S104 to S105.

At S104, based on the reasoning result of the current round of model reasoning and the reasoning result of at least one previously executed round of model reasoning, pseudo-feedback information corresponding to the current round of model reasoning is determined.

The pseudo-feedback information may be determined based on the reasoning result of the current round of model reasoning and the reasoning result of at least one previously executed round of model reasoning, that is, determined based on the current reasoning result and at least one previous reasoning result.

The pseudo-feedback information may be information in any form. In some embodiments, the pseudo-feedback information may be information presented using natural language, for example, text information presented using natural language. In some other embodiments, the pseudo-feedback information may be information presented using feature representation, for example, information presented in any form that the target model is able to understand, such as numerical vectors, matrices, or higher-dimensional tensors. In some embodiments, the pseudo-feedback information may be hidden state information generated during the target model's multi-round model reasoning process for the target task.

The pseudo-feedback information may indicate the relationship between the current reasoning result and at least one previous reasoning result in any suitable manner. In some embodiments, the pseudo-feedback information may be used to indicate whether the current reasoning result is the same as the at least one previous reasoning result. For example, the pseudo-feedback information may be used to indicate that the current reasoning result is the same as all the at least one previous reasoning result, or is the same as some of the previous reasoning results, or is different from each previous reasoning result. In some embodiments, the pseudo-feedback information may be used to indicate the semantic similarity between the current reasoning result and at least one prior reasoning result. For example, algorithms such as Euclidean distance or cosine similarity may be used to determine the semantic similarity between the current reasoning result and at least one prior reasoning result.

At S105, based on the process information of the current round of model reasoning, the high-level reflection information, and the pseudo-feedback information corresponding to the current round of model reasoning, the specific reflection information corresponding to the current round of model reasoning is generated.

Guided by the high-level reflection information, the process information of the current round model reasoning may be reflected upon with reference to the pseudo-feedback information of the current round of model reasoning, thereby obtaining the specific reflection information corresponding to the current round of model reasoning.

In some embodiments, the specific reflection information corresponding to the current round of model reasoning may be generated using the target model or manually, based on the high-level reflection information, and the pseudo-feedback information and the process information corresponding to the current round of model reasoning.

In some embodiments, the specific reflection information corresponding to the current round of model reasoning may be generated based on the process information of the current round of model reasoning, and the process information, high-level reflection information, and pseudo-feedback information of at least one previously executed round of model reasoning.

In the present disclosure, the pseudo-feedback information may be used to assist the target model in judging whether the process information of the current round of model reasoning is correct or reasonable from the perspective of the reasoning result, thereby determining more reasonable specific reflection information. Also, since the pseudo-feedback information is determined based on the reasoning result of the current round of model reasoning and at least one previously executed reasoning result, the present disclosure may have higher feasibility in practical application scenarios, compared to the existing technologies which use real labels to guide self-correction.

In some implementations, S104, determining the pseudo-feedback information corresponding to the current round of model reasoning based on the reasoning result of the current round of model reasoning and the reasoning result of at least one previously executed round of model reasoning, may include:

S1041, determining the pseudo-feedback information based on whether the reasoning result of the current round of model reasoning matches the reasoning result of the at least one previously executed round of model reasoning.

Whether the reasoning result of the current round of model reasoning matches the reasoning result of at least one previously executed round of model reasoning may be whether the current reasoning result matches at least one prior reasoning result.

In some embodiments, whether the current reasoning result matches at least one prior reasoning result may include whether the current reasoning result is the same as or consistent with at least one prior reasoning result. For example, when the reasoning result is a numerical value, a match may be determined by determining whether the numerical value of the current reasoning result is the same as the numerical value of at least one prior reasoning result.

In some other embodiments, whether the current reasoning result matches at least one prior reasoning result may include whether the current reasoning result is similar to at least one prior reasoning result. For example, when the reasoning result is a numerical value, a match may be determined by determining whether the numerical value of the current reasoning result is the same as the numerical value of at least one prior reasoning result, or whether the absolute value of the difference is within a specified threshold range. As another example, when the reasoning result is text, a match may be determined by determining whether the semantic information of the current reasoning result is similar to the semantic information of at least one prior reasoning result.

When the current reasoning result matches at least one prior reasoning result, the pseudo-feedback information may be, for example, “The answer matches, which may be correct, but it's also possible you guessed wrong due to overconfidence.” When the current reasoning result does not match at least one prior reasoning result, the pseudo-feedback information may be, for example, “The answer does not match, which must mean there was an error in some reasoning. Please reflect on the error and provide a solution.” Therefore, through the pseudo-feedback information, the target model may reflect on the process information of the current round of model reasoning and/or the process information of at least one prior round of model reasoning, to determine a more reasonable and accurate model reasoning process.

In some embodiments, the data processing method may further include:

S106, for each round of model reasoning, after generating the specific reflection information corresponding to the round of model reasoning, updating the high-level reflection information using the specific reflection information corresponding to the round of model reasoning.

For each round of model reasoning, after generating the specific reflection information corresponding to the round of model reasoning based on the process information of model reasoning, the high-level reflection information, and/or the pseudo-feedback information, the high-level reflection information may be updated based on the specific reflection information, such that the updated high-level reflection information may be used to guide the generation of the specific reflection information corresponding to the next round of model reasoning.

In some embodiments, reflection information in the specific reflection information corresponding to that round of model reasoning that is able to be used for other model reasoning tasks may be identified as general reflection information, and this general reflection information may be used to update the high-level reflection information.

In some embodiments, after determining the general reflection information in the specific reflection information corresponding to that round of model reasoning, summary information of the general reflection information may be determined using any type of Summarization processing algorithm, and the summary information may be added to the high-level reflection information, thereby achieving the update of the high-level reflection information. In some embodiments, the Summarization processing algorithm may include, but is not limited to, extractive summarization algorithms (e.g., Term Frequency-Inverse Document Frequency (TF-IDF) algorithm, TextRank algorithm, etc.) or generative summarization algorithms (e.g., Sequence-to-Sequence (Seq2Seq) algorithm, GPT series models, etc.).

In some other embodiments, the general reflection information corresponding to the specific reflection information of the round of model reasoning may be manually determined, and then the summary information of the general reflection information may be determined. This summary information may then be added to the high-level reflection information, thereby updating the high-level reflection information.

In some embodiments, updating the high-level reflection information using the specific reflection information corresponding to the round of model reasoning (S106) may include:

S1061, based on the specific reflection information corresponding to the round of model reasoning and the high-level reflection information, generating the summary information and using the summary information as the updated high-level reflection information.

Summarization processing may be performed on the specific reflection information corresponding to the round of model reasoning and the high-level reflection information to obtain the summary information, and the summary information may be used as the updated high-level reflection information. In some embodiments, a specified summarization algorithm may be used to generate the summary information based on the specific reflection information and high-level reflection information corresponding to the round of model reasoning. In some other embodiments, the summary information of the specific reflection information and high-level reflection information corresponding to the round of model reasoning may be determined manually.

For example, when the high-level reflection information is “Ensure consistency between the question and the answer” and the specific reflection information is “My reasoning process in this attempt was flawed . . . This error highlights the importance of verifying information and the fact that assumptions cannot be made based on partial connections. To improve, I need to conduct searches that are more targeted and ensure the accuracy of information before drawing conclusions,” performing summarization processing on the high-level and the specific reflection information may result in the summary information, that is, the updated high-level reflection information may be “Ensure consistency between the question and the answer, and do not make assumptions based on partial connections.”

As another example, when the high-level reflection information is “Ensure consistency between the question and the answer, and do not make assumptions based on partial connections” and the specific reflection information is “My reasoning process in this attempt was accurate . . . This attempt demonstrates the importance of thorough research and logical reasoning for arriving at the correct answer,” performing summarization processing on the high-level and the specific reflection information may yield the summary information, and the updated high-level reflection information may be “Ensure consistency between the question and the answer, and do not make assumptions based on partial connections. Thorough research and logical reasoning are needed.”

In the present disclosure, after each round of model reasoning, the high-level reflection information may be updated using the specific reflection information corresponding to that round of model reasoning. This may allow the high-level reflection information to be continuously updated as the number of model reasonings performed by the target model increases, becoming dynamically evolving, cross-task, and summarizing reflection information. This may provide multi-faceted guidance for generating specific reflections, making it easier for the target model to obtain accurate specific reflections and reasoning processes.

In some embodiments, determining the prompt information for the current round of model reasoning based on the specific reflection information corresponding to the preceding round of model reasoning (S101) may include:

S1011, updating the prompt information of the preceding round of model reasoning using the specific reflection information and process information corresponding to the preceding round of model reasoning, and using the updated prompt information as the prompt information for the current round of model reasoning.

In some embodiments, when determining the prompt information for the current round of model reasoning, the prompt information of the preceding round of model reasoning may be updated with the specific reflection information and reasoning process information corresponding to the preceding round of model reasoning, and the updated prompt information of the preceding round of model reasoning may be used as the prompt information for the current round of model reasoning.

In some embodiments, when determining the prompt information for the current round of model reasoning, the process information from the preceding round of model reasoning may be updated to the prompt information of the preceding round of model reasoning. Simultaneously, the prompt information of the preceding round of model reasoning may be adjusted using the specific reflection information of the preceding round of model reasoning (e.g., adjusting the reasoning steps, intermediate result generation methods, or reasoning result generation methods specified in the preceding round), resulting in adjusted prompt information of the preceding round of model reasoning. This adjusted prompt information may then be used as the prompt information of the current round of model reasoning.

When performing the current round of model reasoning, the target model may adjust the reasoning process of this round of model reasoning based on the specific reflection information of the preceding round of model reasoning in the prompt information, predict the reasoning result of the target task from different perspectives, or predict the reasoning result of the target task based on the adjusted reasoning steps, reasoning result generation methods, etc. Further, after completing the current round of model reasoning, the target model may, under the guidance of high-level reflection, generate the specific reflection information corresponding to the current round of model reasoning based on the process information of this round of model reasoning and the process information of the preceding round of model reasoning in the prompt information.

In some embodiments, the prompt information of the current round of model reasoning may include process information of a specified number of previously executed model reasoning iterations, which allows the target model to reflect on the process information from multiple rounds of model reasoning under the guidance of high-level reflection, thereby making the specific reflection information more accurate.

In some embodiments, when the target task corresponding to the target reasoning result is the first reasoning task executed by the target model, the data processing method may further include one of S107 or S108.

At S107, when the reasoning result of the first round of model reasoning for the target task indicates that reasoning is complete, first initial information is used as the high-level reflection information, where the first initial information is used to instruct the target model to maintain consistency between the reasoning result and the target task.

The high-level reflection information may be continuously evolving and updated reflection information. When the target task is the first reasoning task executed by the target model, the high-level reflection information may need to be initialized.

Reasoning completion may be the generation of the reasoning result for the target task after the target model executes a specified number of model reasoning steps in a round of model reasoning, i.e., the reasoning result of that round of model reasoning. In some embodiments, when the target model outputs the reasoning result of the first round of model reasoning, or when a keyword indicating reasoning completion exists in the reasoning trajectory, the first round of model reasoning for the target task by the target model may be considered to be in a state of reasoning completion.

When the first round of reasoning is in a completed state, the high-level reflection information may be initialized as the first initial information to instruct the target model to maintain consistency between the reasoning result and the target task, thereby prompting the target model to maintain the accuracy and appropriateness of the reasoning result.

At S108, when the reasoning result of the first round of model reasoning for the target task indicates that the reasoning is incomplete, second initial information is used as the high-level reflection information, where the second initial information may be used to instruct the target model to avoid the same reasoning process.

Incomplete reasoning may mean that in a round of model reasoning, the target model does not generate a reasoning result for the target task after executing the maximum number of reasoning steps. In some embodiments, when the target model does not output the reasoning result of the first round of model reasoning, or when there are keywords in the reasoning trajectory indicating incomplete reasoning, the first round of model reasoning for the target task may be considered to be in an incomplete state.

When the first round of model reasoning is in the incomplete state, the high-level reflection information may be initialized as second initial information to instruct the target model to avoid the same reasoning process, instructing the target model to adjust the reasoning process when incomplete reasoning, to try to use different reasoning strategies to execute the next round of model reasoning, thereby increasing the probability that the target model obtains the correct reasoning result.

In some embodiments, determining the target reasoning result based on the reasoning results of at least two rounds of model reasoning (S103) may include:

S1031: determining the target reasoning result from the reasoning results of the at least two rounds of model reasoning based on the relevance of the reasoning results of the at least two rounds of model reasoning.

When only one reasoning result is generated in the at least two rounds of model reasoning (i.e., only one round of model reasoning is in a completed state), that single reasoning result may be determined as the target reasoning result. When at least two reasoning results are generated in the at least two rounds of model reasoning, the target reasoning result may be determined based on the relevance of the reasoning results of the at least two rounds of model reasoning, i.e., based on the relevance of the at least two reasoning results.

In some embodiments, the relevance of the at least two reasoning results may be whether the at least two reasoning results are the same. That is, when the at least two reasoning results are the same, the relevance may be considered high, while when the at least two reasoning results are different, the relevance may be considered low. Therefore, determining the target reasoning result based on the relevance of the at least two reasoning results may mean that the identical reasoning results among the at least two reasoning results are determined as the target reasoning result. For example, when at least two reasoning results are result A, result B, and result C, if result A is the same as result B, and both result A and result B are different from result C, result A and result B may be determined as the target reasoning result.

In some other embodiments, the relevance of the at least two reasoning results may be their semantic similarity. That is, the semantic similarity of the at least two reasoning results may be used as their relevance. Therefore, the target reasoning result may be determined based on the relevance of the at least two reasoning results, i.e., the target reasoning result may be determined based on at least two reasoning results with high similarity. For example, when the at least two reasoning results are result D, result E, and result F, if result D has a high semantic similarity to result E, and both result D and result E have low semantic similarity to result F, the target reasoning result may be determined based on the semantic information of result D and result E. For example, summarizing result D and result E may be performed, or the average of result D and result E may be calculated to obtain the target reasoning result.

In some embodiments, when the relevance between any two of the at least two reasoning results is low, the reasoning result of the last round of model reasoning may be taken as the target reasoning result.

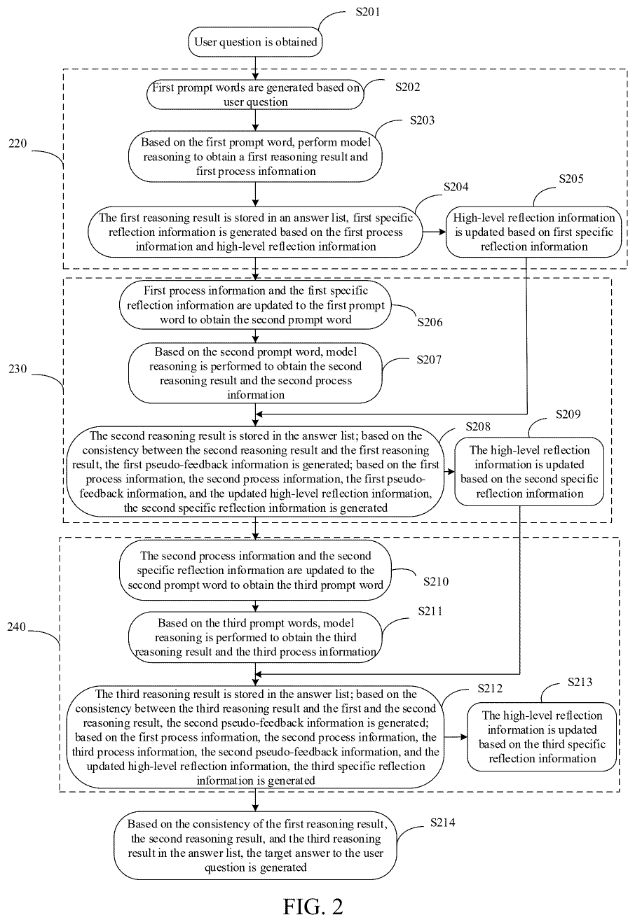

An implementation of the data processing method provided by the present disclosure, will be described below, with reference to FIG. 2. As shown in FIG. 2, the implementation includes S201 to S214. S202 to S205 shown in the dashed box 220 are the first round of model reasoning for a user question. S206 to S209, shown in the dashed box 230, are the second round of model reasoning for the user question; and S210 to S213, shown in the dashed box 240, are the third round of model reasoning for the user question.

At S201, the user question is obtained and then S202 is executed.

At S202, first prompt words are generated based on the user question, and then S203 is executed.

The first prompt words may include the user question, and may also include at least one reasoning example and a keyword description of the reasoning example. The reasoning example may be a reasoning example performed on the HotPotQA dataset based on the synergizing reasoning and acting (ReAct) framework in language models, as shown in the following contents:
“Thinking 1: I need to search for information related to the Livesehal War Memorial . . .
Action 1: Search for [Livesehal War Memorial]
Observation 1: Unable to find [Livesehal War Memorial]. Similar information: [‘Danny Glover Filmography’] . . .
Thinking 2: I need to adjust my search . . . Try searching for “Livesehal War Memorial Address” . . .
Action 2: Search for [Livesehal War Memorial Address]
Observation 2: Unable to find [Livesehal War Memorial Address]. Similar information: [‘James Stewart’], . . .
Thinking 3: I need . . . Try different methods . . . Try searching for “Livesehal War Memorial History” . . .
Action 3: Search for [Livesehal War Memorial History]
Observation 3: Unable to find [Livesehal War Memorial History]. Similar information: [‘James Stewart’], . . .
Reflection 4: I'm encountering challenges in my search . . . Get more detailed information . . . This will help me overcome the lack of specific search results and provide a more accurate answer.
Action 4: Search for [War Memorials Commemorating Over 60 Million Casualties]
Observation 4: World War II was the deadliest military conflict in human history.
Reflection 5: Based on the collected information, World War II resulted in over 60 million casualties . . .
Action 5: Complete [World War II].”

The prompts explaining the keywords in the reasoning examples may include, for example, explanations of “reflection,” “action,” “observation,” and “complete” in the above reasoning examples.

At S203, based on the first prompt word, model reasoning is performed to obtain a first reasoning result and first process information, and then S204 is executed.

At S204, the first reasoning result is stored in an answer list, first specific reflection information is generated based on the first process information and high-level reflection information, and then S205 and S206 are executed.

At S205, the high-level reflection information is updated based on the first specific reflection information, and then S208 is executed.

Summarization processing may be performed on the first specific reflection information and high-level reflection information to obtain summary information, and this summary information may be used as the updated high-level reflection information.

At S206, first process information and the first specific reflection information are updated to the first prompt word to obtain a second prompt word, and then S207 is executed.

At S207, based on the second prompt word, model reasoning is performed to obtain the second reasoning result and the second process information, and then S208 is executed.

At S208, the second reasoning result is stored in the answer list; based on the consistency between the second reasoning result and the first reasoning result, the first pseudo-feedback information is generated; based on the first process information, the second process information, the first pseudo-feedback information, and the updated high-level reflection information, the second specific reflection information is generated, and then S209 and S210 are executed.

When the second reasoning result is the same as the first reasoning result, the first pseudo-feedback information may be “The answers are the same, the answers may be correct, but it is also possible that you guessed the answers wrong because you were overconfident. When the second reasoning result is different from the first reasoning result, the first pseudo-feedback information may be “The answers are inconsistent, there must be an error in some reasoning, please reflect on the error and provide a solution.” Then, guided by the high-level reflection information updated in S205, the second specific reflection information may be generated based on the first process information, the second process information, and the first pseudo-feedback information.

At S209, the high-level reflection information is updated based on the second specific reflection information, and then S212 is executed.

Summarization processing may be performed on the second specific reflection information and the high-level reflection information updated in S205 to obtain the summary information, and this summary information may be used as the updated high-level reflection information.

At S210, the second process information and the second specific reflection information are updated to the second prompt word to obtain a third prompt word, and then S211 is executed.

At S211, based on the third prompt word, model reasoning is performed to obtain the third reasoning result and the third process information, and then S212 is executed.

At S212, the third reasoning result is stored in the answer list; based on the consistency between the third reasoning result and the first and the second reasoning result, the second pseudo-feedback information is generated; based on the first process information, the second process information, the third process information, the second pseudo-feedback information, and the updated high-level reflection information, the third specific reflection information is generated; and then S213 and S214 are executed.

When the third reasoning result is the same as the first reasoning result and/or the second reasoning result, the first pseudo-feedback information may be “The answers are consistent, the answers may be correct, but it is also possible that you guessed the answer incorrectly due to overconfidence.” When the third reasoning result is different from both the first reasoning result and the second reasoning result, the first pseudo-feedback information may be “The answers are inconsistent, there must be an error in some reasoning, please reflect on the error and provide a solution.” Then, guided by the high-level reflection information updated in S209, the third specific reflection information may be generated based on the first process information, the second process information, the third process information, and the second pseudo-feedback information.

At S213, the high-level reflection information is updated based on the third specific reflection information.

Summarization processing may be performed on the third specific reflection information and the high-level reflection information updated in S209 to obtain the summary information, and this summary information may be used as the updated high-level reflection information again. The updated high-level reflection information may be stored in a designated memory such that when the target model receives the next model processing task, the updated high-level reflection information may be used to guide the generation of specific reflection information.

At S214, based on the consistency of the first reasoning result, the second reasoning result, and the third reasoning result in the answer list, the target answer to the user question is generated.

When the first reasoning result, the second reasoning result, and the third reasoning result are all the same, or when two of the first reasoning result, the second reasoning result, and the third reasoning result are the same, the same reasoning result may be taken as the target answer. When the first reasoning result, the second reasoning result, and the third reasoning result are all different, the third reasoning result may be taken as the target answer.

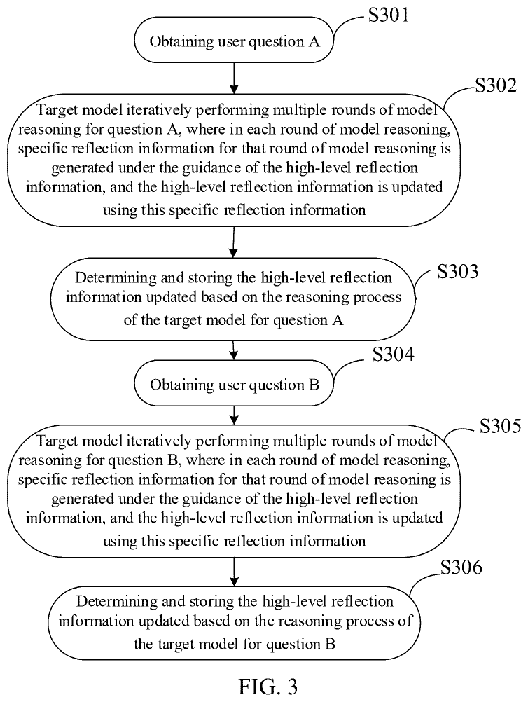

The following, with reference to FIG. 3, describes an embodiment of dynamically updating the high-level reflection information according to the data processing method provided by the present disclosure. As shown in FIG. 3, this embodiment includes:

S301: obtaining user question A, and then executing S302;

S302: the target model iteratively performing multiple rounds of model reasoning for question A, where in each round of model reasoning, specific reflection information for that round of model reasoning is generated under the guidance of the high-level reflection information, and the high-level reflection information is updated using this specific reflection information; and then, executing S303; where, in the multiple rounds of iterative model reasoning for question A by the target model, the high-level reflection information is iteratively updated.

S303: determining and storing the high-level reflection information updated based on the reasoning process of the target model for question A; and then, executing S304, where, after the target model completes the last round of model reasoning for question A, the updated high-level reflection information corresponding to the last round of model reasoning is used as the high-level reflection information updated based on the reasoning process of the target model for question A.

S304: obtaining user question B; and then, executing S305;

S305: the target model iteratively performing multiple rounds of model reasoning for question B; and in each round of model reasoning, generating specific reflection information for that round of model reasoning under the guidance of the updated high-level reflection information, where this specific reflection information is used to update the high-level reflection information; and then, executing S306;

S306: determining and storing the high-level reflection information updated based on the reasoning process of the target model for question B.

In the data processing method provided by the present disclosure, by dynamically updating the high-level reflection information under different problem environments, the high-level reflection information may be dynamically evolving, cross-problem, and summative. Multi-faceted reflections and experiences may be provided when guiding the generation of specific reflection information, making the specific reflection information more reasonable and accurate.

To verify the effectiveness of the data processing method provided by the present disclosure, corresponding test cases may be designed.

First, a test dataset may be prepared, where the test dataset may include test questions and standard answers selected from HotPotQA.

Then, GPT-3.5 and GPT-4 may be used as target models, and a single reasoning iteration may be performed according to the reasoning examples in the ReAct framework. The pseudo-feedback information and high-level reflection information may be designed for GPT-3.5 and GPT-4 respectively, following the implementation methods of the pseudo-feedback information and the high-level reflection information described above, to obtain improved GPT-3.5 and GPT-4 models.

Finally, following the model reasoning process described above, the improved GPT-3.5 and GPT-4 may be used to reason the test questions in the test dataset, obtaining the reasoning result for each test question. For each test question, GPT-3.5 and GPT-4 may iterate for three rounds, resulting in three reasoning results for each test question.

After the above tests, the three reasoning results generated by the improved GPT-3.5 and GPT-4 for each test question may be compared with the standard answer to obtain the accuracy of the reasoning results for each round of model reasoning, as shown in Table 1 below:

TABLE 1
List of Reasoning Result Accuracy

| | First Round | Second Round | Third Round |
|---|---|---|---|
| | Reasoning Result | Reasoning Result | Reasoning Result |
| Model Name | Accuracy | Accuracy | Accuracy |
| GPT-3.5 | 0.35 | 0.38 | 0.41 |
| GPT-4 | 0.43 | 0.49 | 0.49 |

As can be seen from Table 1, under the standard prompt words, the accuracy of the first round of model reasoning results obtained by using the ReAct reasoning example is 0.35 and 0.43, respectively. Based on the first round of model reasoning, leveraging the role of continuously evolving high-level reflection information, the accuracy of the second round of reasoning results is 0.38 and 0.49, respectively. Based on the first two rounds of model reasoning, leveraging the combined role of pseudo-feedback information and high-level reflection information, the accuracy of the third round of reasoning results is 0.41 and 0.49, respectively. It is evident that, under the combined effect of high-level reflection information and pseudo-feedback information, the accuracy of the third round of reasoning results is improved compared to the accuracy of the first round of reasoning results, demonstrating the effectiveness of the data processing method provided in this disclosure.

The present disclosure also provides a data processing apparatus. Various units and modules within each unit in the data processing apparatus may be implemented using a processor in a computer device; and, alternatively, may also be implemented using specific logic circuits. In various embodiments, the processor may be a Central Processing Unit (CPU), a Microprocessor Unit (MPU), a Digital Signal Processor (DSP), or a Field Programmable Gate Array (FPGA), etc.

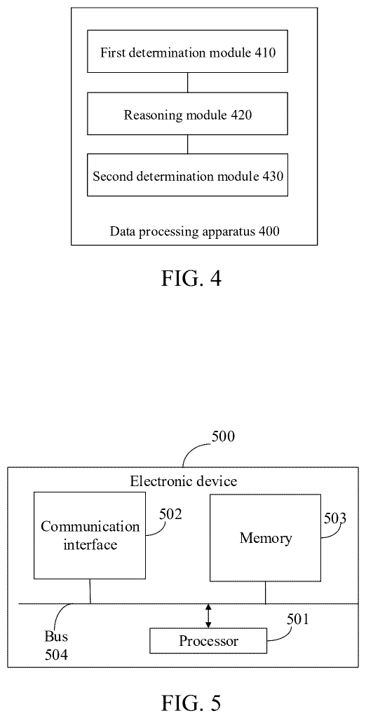

In one embodiment, as shown in FIG. 4, which is a schematic structural diagram of a data processing device provided by the present disclosure, the data processing apparatus may include a first determination module 410, a reasoning module 420, and a second determination module 430.

The first determination module 410 may be configured to determine prompt information of a current round of model reasoning based on specific reflection information corresponding to a preceding round of model reasoning, where the specific reflection information corresponding to the preceding round of model reasoning may be generated based on the process information and high-level reflection information of the preceding round of model reasoning, and the high-level reflection information may represent the cross-task reflection information generated by the target model.

The reasoning module 420, may be configured to, based on the prompt information of the current round of model reasoning, perform the current round of model reasoning using the target model to obtain a reasoning result of the current round of model reasoning.

The second determination module 430 is configured to determine a target reasoning result based on the reasoning results of at least two rounds of model reasoning.

In some embodiments, the data processing apparatus 400 may further include:
a pseudo-feedback information module, configured to determine pseudo-feedback information corresponding to the current round of model reasoning based on the reasoning result of the current round of model reasoning and the reasoning result of at least one previously executed round of model reasoning; and
a specific reflection information module, configured to generate specific reflection information corresponding to the current round of model reasoning based on the process information of the current round of model reasoning, and the pseudo-feedback information and the high-level reflection information corresponding to the current round of model reasoning.

In some embodiments, the pseudo-feedback information module may be configured to determine the pseudo-feedback information based on whether the reasoning result of the current round of model reasoning matches the reasoning result of at least one previously executed round of model reasoning.

In some embodiments, the data processing apparatus 400 may further include: an update module, configured to update the high-level reflection information using the specific reflection information corresponding to the model reasoning after generating the specific reflection information for each round of model reasoning.

In some embodiments, the update module may be configured to generate summary information based on the specific reflection information corresponding to the model reasoning and the high-level reflection information, and use the summary information as the updated high-level reflection information.

In some embodiments, the first determining module 410 may be configured to update the prompt information of the preceding round of model reasoning using the specific reflection information and process information corresponding to the preceding round of model reasoning, and use the updated prompt information as the prompt information of the current round of model reasoning.

In some embodiments, when the target task corresponding to the target reasoning result is the first reasoning task executed by the target model, the data processing apparatus 400 may further include a high-level reflection information module.

The high-level reflection information module may be configured to perform one of:
when the reasoning result of the first round of model reasoning for the target task indicates that the reasoning is complete, using first initial information as the high-level reflection information, where the first initial information is used to instruct the target model to maintain consistency between the reasoning result and the target task; or
when the reasoning result of the first round of model reasoning for the target task indicates that the reasoning is not complete, using second initial information as the high-level reflection information, where the second initial information is used to instruct the target model to avoid the same reasoning process.

In some embodiments, the second determining module 430 may be configured to determine the target processing result from the reasoning results of the at least two rounds of model reasoning based on the relevance of the reasoning results of the at least two rounds of model reasoning.

The descriptions of the above apparatus embodiments are similar to those of the above method embodiments, and have similar beneficial effects. In some embodiments, the functions or modules included in the apparatus provided by the present disclosure can be used to execute the methods described in the above method embodiments. For technical details not disclosed in the apparatus embodiments of this disclosure, references may be made to the descriptions of the method embodiments of this disclosure for understanding.

It should be noted that, in various embodiments of the present disclosure, when the above data processing method is implemented in the form of software functional modules and sold or used as an independent product, it may also be stored in a computer-readable storage medium. Based on this understanding, the technical solution of the embodiments of this disclosure, in essence, or the part that contributes to the related technology, may be embodied in the form of a software product. This software product may be stored in a storage medium and includes several instructions to cause a computer device (which may be a personal computer, server, or network device, etc.) to execute all or part of the method provided by the various embodiments of this disclosure. The aforementioned storage medium may include various media capable of storing program code, such as USB flash drives, mobile hard drives, read-only memory (ROM), magnetic disks, or optical disks. Thus, the embodiments of this disclosure are not limited to any specific hardware, software, or firmware, or any combination of hardware, software, and firmware.

The present disclosure also provides a computer device including a memory and a processor. The memory may be configured to store a computer program executable on the processor. When the processor executes the program, the computer device may implement some or all of the steps in the method provided by various embodiments of the present disclosure.

The present disclosure also provides a computer-readable storage medium storing a computer program thereon. When the computer program is executed by a processor, the processor may make a device where the processor is located to implement some or all of the steps in the methods described above. The computer-readable storage medium may be transient or non-transient.

The present disclosure also provides a computer program including computer-readable code. When the computer-readable code is executed in a computer device, the processor in the computer device may perform actions to implement some or all of the steps in the methods described above.

The present disclosure also provides a computer program product including a non-transient computer-readable storage medium storing a computer program. When the computer program is read and executed by a computer, the computer may implement some or all of the steps in the methods described above. This computer program product can be implemented specifically through hardware, software, or a combination thereof. In some embodiments, the computer program product may be specifically embodied as a computer storage medium. In some other embodiments, the computer program product may be specifically embodied as a software product, such as a Software Development Kit (SDK), etc.

It should be noted that the descriptions of the various embodiments above tend to emphasize the differences between them, while their similarities or commonalities can be referred to interchangeably. The descriptions of the above embodiments of the device, storage medium, computer program, and computer program product are similar to the descriptions of the above method embodiments and have similar beneficial effects. For technical details not disclosed in the embodiments of the device, storage medium, computer program, and computer program product of this disclosure, references may be made to the descriptions of the method embodiments of this disclosure for understanding.

The present disclosure also provides an electronic device. As shown in FIG. 5, which is a schematic hardware diagram of an electronic device provided by the present disclosure, in one embodiment, the electronic device 500 includes: a processor 501, a communication interface 502, and a memory 503.

The processor 501 may be typically configured to control the overall operation of the electronic device 500.

The communication interface 502 may be configured to enable the electronic device to communicate with other terminals or servers via a network.

The memory 503 may be configured to store instructions or applications executable by the processor 501, and may also cache data to be processed or already processed (e.g., image data, audio data, voice communication data, and video communication data) in the processor 501 and various modules in the electronic device 500. The memory may be implemented using flash memory (FLASH) or random access memory (RAM). Data transfer between the processor 501, the communication interface 502, and the memory 503 may be performed via a bus 504. The instructions stored in the memory 503, when executed by the processor 501, can cause the electronic device 500 to perform a method consistent with the disclosure, such as any of the example methods described above.

It should be understood that the phrase “one embodiment” or “an embodiment” throughout the specification means that a specific feature, structure, or characteristic related to an embodiment is included in at least one embodiment of the present disclosure. Therefore, “in one embodiment” or “in an embodiment” appearing throughout the specification does not necessarily refer to the same embodiment. Furthermore, these specific features, structures, or characteristics can be combined in any suitable manner in one or more embodiments. It should be understood that in the various embodiments of this disclosure, the sequence number of the above steps/processes does not imply a sequential order of execution; the execution order of each step/process should be determined by its function and internal logic, and should not constitute any limitation on the implementation process of the embodiments of this disclosure. The sequence numbers of the embodiments disclosed above are for descriptive purposes only and do not represent the superiority or inferiority of the embodiments.

It should be noted that, in this document, the terms “comprising,” “including,” or any other variations thereof are intended to cover non-exclusive inclusion, such that a process, method, article, or apparatus that includes a list of elements includes not only those elements but also other elements not expressly listed, or elements inherent to such a process, method, article, or apparatus. Without further limitations, an element defined by the phrase “including a . . . ” does not exclude the presence of other identical elements in the process, method, article, or apparatus that includes that element.

In the embodiments provided by the present disclosure, it should be understood that the disclosed devices and methods can be implemented in other ways. The device embodiments described above are merely illustrative. For example, the division of units is only a logical functional division. In actual implementation, there may be other division methods, such as multiple units or components being combined, integrated into another system, or some features being ignored or not executed. Furthermore, the coupling, direct coupling, or communication connection between the various components shown or discussed can be indirect coupling or communication connection through interfaces, devices, or units, and can be electrical, mechanical, or other forms.

The units described above as separate components may or may not be physically separate. The components shown as units may or may not be physical units. They can be located in one place or distributed across multiple network units. Some or all of the units can be selected to achieve the purpose of the present disclosure according to actual needs.

Further, the functional units in the embodiments of this disclosure can all be integrated into one processing unit, or each unit can be a separate unit, or two or more units can be integrated into one unit. The integrated unit can be implemented in hardware or in a combination of hardware and software functional units.

Those skilled in the art should understand that all or part of the steps in the above method embodiments may be implemented by hardware related to program instructions. The aforementioned program may be stored in a computer-readable storage medium. When executed, the program may perform the steps of the above method embodiments. The aforementioned storage medium may include various media capable of storing program code, such as mobile storage devices, read-only memory (ROM), magnetic disks, or optical disks.

Alternatively, when the integrated units of this disclosure are implemented as software functional modules and sold or used as independent products, they may also be stored in a computer-readable storage medium. Based on this understanding, the technical solution of this disclosure, in essence or the part that contributes to related technologies, can be embodied in the form of a software product. This computer software product may be stored in a storage medium and include several instructions to cause a computer device (which may be a personal computer, server, or network device, etc.) to execute all or part of the methods described in the various embodiments of this disclosure. The aforementioned storage medium may include various media capable of storing program code, such as mobile storage devices, ROMs, magnetic disks, or optical disks.

The embodiments of the present disclosure have been described above. However, these embodiments are merely illustrative and not intended to limit the scope of the present disclosure. Although various embodiments have been described above, this does not mean that the measures in the various embodiments cannot be used advantageously in combination. Various substitutions and modifications can be made by those skilled in the art without departing from the scope of the present disclosure, and all such substitutions and modifications should fall within the scope of the present disclosure.

What is claimed is:

1. A data processing method comprising:
performing a plurality rounds of model reasoning, including, for a current round of model reasoning among the plurality rounds of model reasoning:
determining, based on preceding specific reflection information corresponding to a preceding round of model reasoning, current prompt information of the current round of model reasoning, the preceding specific reflection information being generated based on preceding process information of the preceding round of model reasoning and high-level reflection information representing cross-task reflection information generated by a target model; and
executing, based on the current prompt information, the current round of model reasoning using the target model to obtain a current reasoning result of the current round of model reasoning; and
determining a target reasoning result based on one or more reasoning results from at least two rounds of model reasoning among the plurality of rounds of model reasoning.

2. The method according to claim 1, further comprising, for the current round of model reasoning:
determining, based on the current reasoning result and a reasoning result of at least one previously executed round of model reasoning, pseudo-feedback information corresponding to the current round of model reasoning; and
generating specific reflection information corresponding to the current round of model reasoning based on process information of the current round of model reasoning, the pseudo-feedback information, and the high-level reflection information.

3. The method according to claim 2, wherein determining the pseudo-feedback information includes:
determining the pseudo-feedback information based on whether the current reasoning result matches the reasoning result of the at least one previously executed round of model reasoning.

4. The method according to claim 1, further comprising, for the current round of model reasoning:
after generating current specific reflection information corresponding to the current round of model reasoning, updating the high-level reflection information using the current specific reflection information.

5. The method according to claim 4, wherein updating the high-level reflection information includes:
generating, based on the current specific reflection information and the high-level reflection information, summary information as updated high-level reflection information.

6. The method according to claim 1, wherein determining the current prompt information includes:
updating preceding prompt information of the preceding round of model reasoning using the preceding specific reflection information and the preceding process information to obtain updated prompt information as the current prompt information.

7. The method according to claim 1, further comprising, in response to a target task corresponding to the target reasoning result is the first reasoning task executed by the target model:
in response to a reasoning result of the first round of model reasoning for the target task indicating that reasoning is complete, determining initial information as the high-level reflection information, the initial information being configured to instruct the target model to maintain consistency between the reasoning result and the target task.

8. The method according to claim 1, further comprising, in response to a target task corresponding to the target reasoning result is the first reasoning task executed by the target model:
in response to a reasoning result of the first round of model reasoning for the target task indicating that reasoning is not complete, determining initial information as the high-level reflection information, the initial information being configured to instruct the target model to avoid same reasoning process.

9. The method according to claim 1, wherein determining the target reasoning result includes:
determining the target reasoning result from the one or more reasoning results based on a relevance of the one or more reasoning results.

10. An electronic device comprising:
one or more processors; and
one or more memories storing instructions that, when executed by the one or more processors, cause the electronic device to:
perform a plurality rounds of model reasoning, including, for a current round of model reasoning among the plurality rounds of model reasoning:
determining, based on preceding specific reflection information corresponding to a preceding round of model reasoning, current prompt information of the current round of model reasoning, the preceding specific reflection information being generated based on preceding process information of the preceding round of model reasoning and high-level reflection information representing cross-task reflection information generated by a target model; and
executing, based on the current prompt information, the current round of model reasoning using the target model to obtain a current reasoning result of the current round of model reasoning; and
determine a target reasoning result based on one or more reasoning results from at least two rounds of model reasoning among the plurality of rounds of model reasoning.

11. The electronic device according to claim 10, wherein the instructions further cause the electronic device to, for the current round of model reasoning:
determine, based on the current reasoning result and a reasoning result of at least one previously executed round of model reasoning, pseudo-feedback information corresponding to the current round of model reasoning; and
generate specific reflection information corresponding to the current round of model reasoning based on process information of the current round of model reasoning, the pseudo-feedback information, and the high-level reflection information.

12. The electronic device according to claim 11, wherein the instructions further cause the electronic device to, when determining the pseudo-feedback information:
determine the pseudo-feedback information based on whether the current reasoning result matches the reasoning result of the at least one previously executed round of model reasoning.

13. The electronic device according to claim 11, wherein the instructions further cause the electronic device to, for the current round of model reasoning:
after generating current specific reflection information corresponding to the current round of model reasoning, update the high-level reflection information using the current specific reflection information.

14. The electronic device according to claim 13, wherein the instructions further cause the electronic device to, when updating the high-level reflection information:
generate, based on the current specific reflection information and the high-level reflection information, summary information as updated high-level reflection information.

15. The electronic device according to claim 11, wherein the instructions further cause the electronic device to, when determining the current prompt information:
update preceding prompt information of the preceding round of model reasoning using the preceding specific reflection information and the preceding process information to obtain updated prompt information as the current prompt information.

16. The electronic device according to claim 11, wherein the instructions further cause the electronic device to, in response to a target task corresponding to the target reasoning result is the first reasoning task executed by the target model:
in response to a reasoning result of the first round of model reasoning for the target task indicating that reasoning is complete, determine initial information as the high-level reflection information, the initial information being configured to instruct the target model to maintain consistency between the reasoning result and the target task.

17. The electronic device according to claim 11, wherein the instructions further cause the electronic device to, in response to a target task corresponding to the target reasoning result is the first reasoning task executed by the target model:
in response to a reasoning result of the first round of model reasoning for the target task indicating that reasoning is not complete, determine initial information as the high-level reflection information, the initial information being configured to instruct the target model to avoid same reasoning process.

18. The electronic device according to claim 11, wherein the instructions further cause the electronic device to, when determining the target reasoning result:
determine the target reasoning result from the one or more reasoning results based on a relevance of the one or more reasoning results.

19. A non-transitory computer-readable storage medium storing instructions that, when executed by one or more processors, cause an electronic device including the one or more processors to:
perform a plurality rounds of model reasoning, including, for a current round of model reasoning among the plurality rounds of model reasoning:
determining, based on preceding specific reflection information corresponding to a preceding round of model reasoning, current prompt information of the current round of model reasoning, the preceding specific reflection information being generated based on preceding process information of the preceding round of model reasoning and high-level reflection information representing cross-task reflection information generated by a target model; and
executing, based on the current prompt information, the current round of model reasoning using the target model to obtain a current reasoning result of the current round of model reasoning; and
determine a target reasoning result based on one or more reasoning results from at least two rounds of model reasoning among the plurality of rounds of model reasoning.
